(19) United States
(12) Patent Application Publication
(10) Pub. No.: US 2016/0003954 A1
(43) Pub. Date: Jan. 7, 2016

(54) AERIAL VEHICLE ACQUISITION OF SEISMIC DATA

(71) Applicant: Schlumberger Technology Corporation, Sugar Land, TX (US)

(72) Inventors: Floyd L. Broussard III, The Woodlands, TX (US); Hallgrim Ludvigsen, Stavanger (NO); Chad Brockman, Cypress, TX (US); Stephen Whitley, London (GB); Ross Graeber, Spring, TX (US); Duo Chen, Houston, TX (US); Andrew Richardson, Houston, TX (US); Daniel Pupim Kano, Katy, TX (US); Vijay Kumar, Houston, TX (US)

(21) Appl. No.: 14/793,520

(22) Filed: Jul. 7, 2015

Related U.S. Application Data
(60) Provisional application No. 62/021,515, filed on Jul. 7, 2014.

(51) Int. Cl. G01V 1/00; G01V 1/22; B64C 39/02

(52) U.S. Cl. CPC G01V 1/003; B64C 39/024; G01V 1/22; B64C 2201/12

(57) ABSTRACT

Methods and apparatus that facilitate acquisition of seismic data. A plurality of acquisition locations within an area of interest may be determined and provided to aerial vehicles. Seismic data may be received from the aerial vehicle. In another example, an aerial vehicle includes a positioning system that determines location of the apparatus; a seismic sensor that senses seismic data; a memory that stores seismic data; and a transceiver that provides telemetric data and the seismic data to a controller device. In at least one example, a method for acquiring seismic data is provided including receiving location information at an aerial vehicle. The aerial vehicle may navigate to a location based on the location information and a seismic sensor may acquire seismic data. The aerial vehicle may be navigated to a controller device and the acquired seismic data may be provided to the controller device.

### RELATED APPLICATION DATA

This application claims priority to provisional patent application No. 62/021515 entitled “METHODS AND SYSTEMS FOR ACQUIRING DATA USING AN AERIAL VEHICLE AND DRONES,” filed on Jul. 7, 2014, the entire contents of which is incorporated herein by reference.

### BACKGROUND

In various industries, gathering data from remote locations can be a challenge. For example, in the oil and gas industry, performing seismic surveys in remote locations can be a difficult challenge. For example, if seismic equipment has to be deployed via a land vehicle, roads may be employed. If there are no roads, creating them can be time consuming and expensive. In addition, there may be an environmental impact to moving equipment through difficult terrain and into position. These drawbacks may result in locations that are not able to be surveyed unless there are strong reasons to believe that the location may contain resources and that the resulting seismic survey (and the costs associated therewith) are a good investment.

### SUMMARY

Systems, apparatus, computer-readable media, and methods are disclosed for acquisition of seismic data via an aerial vehicle.

In at least one embodiment, a method for acquiring seismic data is provided. The method includes receiving location information at an aerial vehicle including a seismic sensor, navigating the aerial vehicle to a location based on the location information; engaging the seismic sensor; acquiring seismic data by the seismic sensor; and transmitting the seismic data acquired at the seismic sensor to the controller device.

In at least one other embodiment, an apparatus is provided that includes a memory storing a set of instructions; and a processor to execute the stored set of instructions to perform a method to receive an identification of an area of interest; determine a plurality of acquisition locations within the received area of interest; transmit one of the plurality of acquisition locations to an aerial vehicle; and receive seismic data from an aerial vehicle.

In at least one other embodiment, an apparatus is provided that includes an aerial vehicle. The aerial vehicle includes a positioning system that determines location of the apparatus; a seismic sensor that senses seismic data; a memory that stores seismic data that is sensed by the seismic sensor; and a transceiver that provides telemetric data and the seismic data to a controller device.

It will be appreciated that this summary is intended merely to introduce a subset of aspects of the disclosure, presented below. Accordingly, this summary is not to be considered limiting on the disclosure.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a system environment according to one or more embodiments.

FIG. 2 illustrates a schematic view of a processor system, according to one or more embodiments.

FIG. 3 illustrates a schematic view of an aerial vehicle, according to one or more embodiments.

FIG. 4 illustrates a schematic view of a controller device, according to one or more embodiments.

FIG. 5 illustrates a flow diagram of a process performed by a controller device, according to one or more embodiments.

FIG. 6 illustrates a flow diagram of a process performed by an aerial vehicle, according to one or more embodiments.

### DETAILED DESCRIPTION

The following detailed description refers to the accompanying drawings. Wherever convenient, the same reference numbers are used in the drawings and the following description to refer to the same or similar parts. While several embodiments and features of the present disclosure are described herein, modifications, adaptations, and other implementations are possible, without departing from the spirit and scope of the present disclosure.

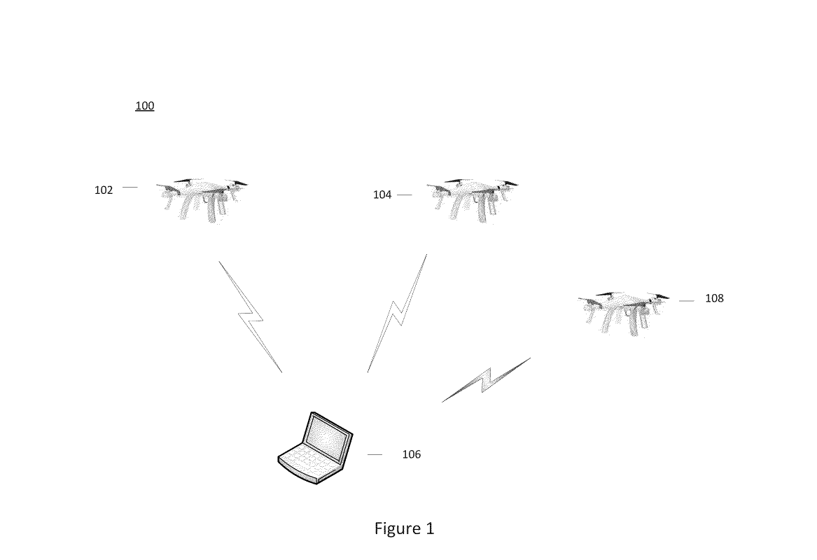

FIG. 1 illustrates a system environment 100 in which embodiments of the present disclosure may be implemented. As shown in FIG. 1, system environment includes a plurality of aerial vehicles 102 and 104. Aerial vehicles 102 and 104 may be implemented as a remote controlled or autonomous aerial vehicle including, but not limited to, a quadcopter, a helicopter, or any other aerial vehicle suitable to carry, deploy, and acquire seismic data from a seismic sensor. As discussed herein, seismic data refers to data that is acquired by the seismic sensor. The aerial vehicle may be remotely controlled via radio by a human operator or may be autonomous in that it may be programmed with computer readable instructions causing the aerial vehicle to fly without human intervention. The aerial vehicles may further be equipped with data gathering components such as cameras, microphones, or other components as more fully discussed below. In some embodiments, the aerial vehicles include wireless communications components to facilitate communication with the controller vehicle and/or other aerial vehicles within system environment 100. The aerial vehicles may also be equipment with a global positioning system (hereinafter “GPS”) to facilitate the aerial vehicles in flying to acquisition locations and controller device locations, and to position themselves accurately, such that seismic data may be acquired by the aerial vehicles 102 and 104. Although only two aerial vehicles 102 and 104 are depicted, more than two aerial vehicles that acquire seismic data may operate within system environment 100.

System environment 100 further includes a controller device 106. Although only one controller device 106 is depicted, other controller devices 106 may be implemented within system environment 100. Controller device 106 may be housed in, located on, or provided at a land vehicle, such as a car, a truck, or any other suitable seismic acquisition control vehicle, or an aerial vehicle, such as a manned or unmanned central aerial vehicle such as an airplane, helicopter, airship (dirigible) or any other suitable aerial seismic acquisition control vehicle. The seismic acquisition control vehicle including the controller device may include docking stations communicably linked to the controller device 106 for the aerial vehicles. The docking stations may provide electrical power to charge batteries on the aerial vehicles. The docking stations may also include data transfer connections, wired or wireless, that allow data to be retrieved from the aerial vehicles and data to be sent to the aerial vehicles. In some embodiments, the seismic acquisition control vehicle includes an inductive charging landing plate that includes magnets in order to facilitate proper positioning of an aerial vehicle on the plate when the aerial vehicle lands. Inductive charging may occur when the aerial vehicle is positioned on the inductive charging landing plate.

The seismic acquisition control vehicle including controller device 106 may transport the aerial vehicles 102 and 104 to and from an acquisition site where seismic data is to be acquired. The controller device 106 may work together with the aerial vehicles 102 and 104 to gather data. The aerial vehicles 102 and 104 may leave the seismic acquisition control vehicle, fly to an assigned acquisition location, acquire seismic data, and return to the seismic acquisition control vehicle to provide the acquired seismic data to the controller device 106.

For example, in certain embodiments, when returning aerial vehicles dock with the docking station, the data gathered by the aerial vehicles is transferred to the data storage devices located at the controller device 106 or external from the controller device 106 in the seismic acquisition control vehicle. The data transfer may occur automatically once the aerial vehicles dock with the docking station via a wired or wireless communication protocol or when the aerial vehicles land on the inductive charging landing plate. In some embodiments, a combination of wired and wireless communication may be used. For example, some data may be communicated wirelessly in real time, while other data is communicated over a wired connection when the aerial vehicle returns to the seismic acquisition control vehicle.

In some embodiments, seismic data that is acquired by the aerial vehicles may be provided to the controller device 106 in real time as the seismic data is acquired.

In some embodiments, the docking station can also be used to relay instructions to the aerial vehicles. For example, the aerial vehicles may be instructed to delete the gathered data after the data transfer is successfully completed, thus allowing space for future data gathering operations. The aerial vehicles may also receive instructions such as acquisition location information, flight patterns for the aerial vehicles to execute autonomously, and/or other information that may be used by the aerial vehicles to acquire seismic data as more fully discussed below. The aerial vehicles may receive instructions to power on, power off, to begin a data gathering operation, provide the acquired seismic data and telemetric data, or other instructions. As discussed herein, seismic data refers to data that is acquired by a seismic sensor. Telemetric data refers to data that is generated at an aerial vehicle and includes information regarding the aerial vehicle including, but not limited to, health of the aerial vehicle such as battery level, overall functionality of the aerial vehicle including motor speed, onboard electronics health, telemetry signal strength, and available memory, information regarding hazards of obstructions, and information regarding location and heading. Telemetric data may further include information related to the current workflow status including location data received for deployment, ready to deploy, clear landing area, within acceptable bounded area based on acquisition locations, stable landing, seismic sensor deployment or engagement, good ground contact of the seismic sensor, recorded drops of seismic sensors of other aerial vehicles, request to record received, recording, recording success, ready to redeploy/return, returning/redeploying, properly docked, transferring seismic data, successful data transfer, and other types of telemetric data as more fully discussed herein.

System environment 100 may further include a source device 108. Although only one source device 108 is depicted, other source devices may be implemented within system environment 100. Source device 108 may be implemented as an aerial vehicle similar to aerial vehicles 102 and 104, a thumper device such as a thumper truck, or any other source generating device sufficient to generate seismic activity. In some embodiments where the source device 108 is implemented as an aerial vehicle, source device 108 may be communicably linked to controller device 106 and/or aerial vehicles 102 and 104. Source device 108 may be configured to generate seismic activity by, for example dropping a source such as an explosive in order to generate seismic activity.

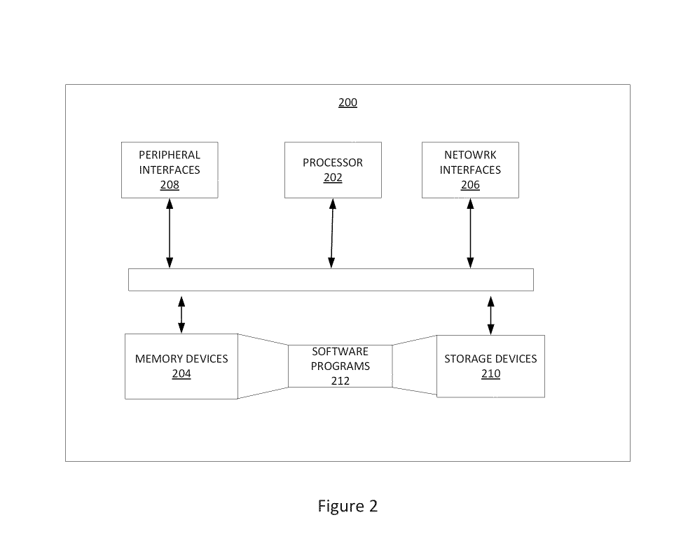

FIG. 2 illustrates a schematic view of some of the hardware components of a computing or processor system 200 of an aerial vehicle and/or a controller device, according to some embodiments. The processor system 200 may include one or more processors 202 of varying core configurations (including multiple cores) and clock frequencies. The one or more processors 202 may be operable to execute instructions, apply logic, etc. It will be appreciated that these functions may be provided by multiple processors or multiple cores on a single chip operating in parallel and/or communicably linked together. In at least one embodiment, the one or more processors 202 may be or include one or more graphics processing units (“GPUs”).

The processor system 200 may also include a memory system, which may be or include one or more memory devices and/or computer-readable media 104 of varying physical dimensions, accessibility, storage capacities, etc. such as flash drives, hard drives, disks, random access memory, etc., for storing data, such as images, files, and program instructions for execution by the processor 202. In an embodiment, the computer-readable media 204 may store instructions that, when executed by the processor 202, are configured to cause the processor system 200 to perform operations. For example, execution of such instructions may cause the processor system 200 to implement one or more portions and/or embodiments of the method described above.

The processor system 200 may also include one or more network interfaces 206. The network interfaces 206 may include any hardware, applications, and/or other software. Accordingly, the network interfaces 206 may include Ethernet adapters, wireless transceivers, PCI interfaces, and/or serial network components, for communicating over wired or wireless media using protocols, such as Ethernet, wireless Ethernet, etc., and may be used to operate the processor system 200 in a mesh network configuration, a hub and spoke network configuration, or any other configuration suitable to implement the seismic data acquisition as discussed herein.

Where the processor system 200 depicts the controller device, the processor system 200 may further include one or more peripheral interfaces 208, for communication with a display screen, projector, keyboards, mice, touchpads, sensors, other types of input and/or output peripherals, and/or the like. In some implementations, the components of processor system 200 need not be enclosed within a single enclosure or even located in close proximity to one another, but in other implementations, the components and/or others may be provided in a single enclosure.

The memory device 204 may be physically or logically arranged or configured to store data on one or more storage devices 210. The storage device 210 may include one or more file systems or databases in any suitable format. The storage device 210 may also include one or more software programs 212, which may contain interpretable or executable instructions for performing one or more of the disclosed processes. When requested by the processor 202, one or more of the software programs 212, or a portion thereof, may be loaded from the storage devices 210 to the memory devices 204 for execution by the processor 202.

The software, computer-readable instructions, and applications described herein may be implemented as either software, firmware and/or hardware applications and may be implemented as a set of computer or machine-readable instructions stored in any type of non-transitory computer-readable or machine-readable storage medium or other storage device. Some non-limiting examples of non-transitory computer-readable mediums may be embodied using any currently known media such as magnetic or optical storage media including removable media such as floppy disks, compact discs, DVDs, flash memory, hard disk drives, etc. In addition, the storage device(s) as discussed herein may comprise a combination of non-transitory, volatile or nonvolatile memory such as random access memory (RAM) or read only memory (ROM). One or more storage devices has stored thereon instructions that may be executed by the one or more processors, such that the processor(s) implement the functionality described herein. In addition, or alternatively, some or all of the software-implemented functionality of the processor(s) may be implemented using firmware and/or hardware devices such as application specific integrated circuits (ASICs), programmable logic arrays, state machines, etc.

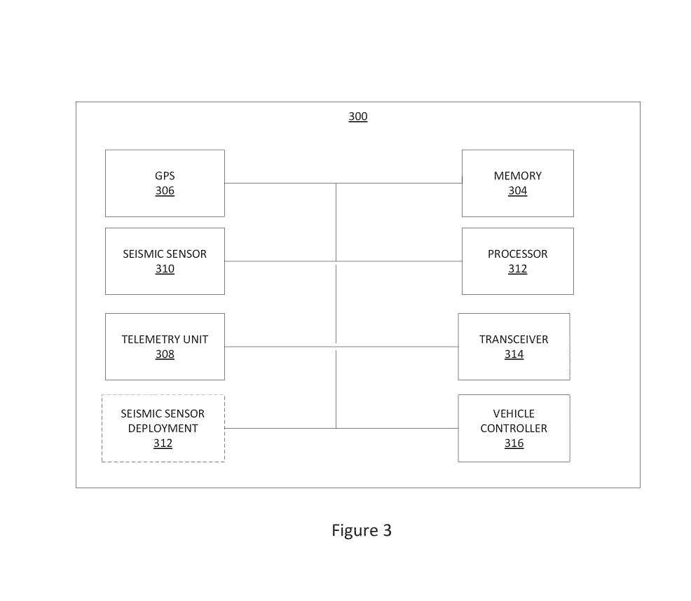

FIG. 3 illustrates additional components of an aerial vehicle 300 according to one or more embodiments. As shown in FIG. 3, aerial vehicle 300 may include a processor 302 and a memory 304, which may be implemented in a manner similar to the implementation of processors 202, memory devices 204 and storage devices 210 as discussed above with regard to FIG. 2. Area vehicle 300 may also include and/or be configured to execute software suitable to process data to facilitate the functionality as discussed herein. Aerial vehicle 300 may further include a GPS 306. In an autonomous aerial vehicle, the GPS may be configured to receive location information and navigate the aerial vehicle to a location based on the received location information without human intervention. The location information may identify one or more acquisition locations where seismic data may be acquired, the location of the controller device, and other locations as discussed herein.

The aerial vehicle 300 may further include a telemetry unit 308. Telemetry unit 308 may determine telemetric data including location information determined by the GPS 306, operational information of components in the aerial vehicle 300 including operational status and/or state, and other types of telemetric data as more fully discussed herein.

The aerial vehicle 300 may further include a seismic sensor 310. The seismic sensor 310 may be implemented as, for example, a geophone, or any other seismic sensor that may be suitable to perform the functionality as discussed herein. The seismic sensor 310 may be implemented as an integrated seismic sensor that integrated in the aerial vehicle 300 and is not configured to deploy from the aerial vehicle 300. When the aerial vehicle 300 is positioned at an acquisition location, the seismic sensor 310 is configured to engage with a ground such that seismic data may be acquired by the seismic sensor 310.

According to some embodiments, the seismic sensor 310 may be implemented as a seismic sensor that may be stored on the aerial vehicle 300 and deployed from the aerial vehicle 300 via seismic sensor deployment 312 by employing, for example, a deployment mechanism such as a latch or any other suitable deployment mechanism, when the aerial vehicle 300 is positioned at an acquisition location. According to some embodiments, the seismic sensor 310 may be connected to the aerial vehicle 300 via a cable. The deployment mechanism may enable the seismic sensor 310 to deploy from the aerial vehicle 300 and drop, under a force due to gravity, to the ground. The seismic sensor 310 may be shaped in manner so as to embed into the ground. For example, the seismic sensor may have a point on at least one portion thereof, such as a spear or an arrowhead, or other types of configurations that would enable the seismic sensor 310 to facilitate the embedding into the ground. When the seismic sensor is embedded in the ground, it may acquire seismic data and transmit the seismic data to the aerial vehicle 310, via the cable.

According to some embodiments, the seismic sensor 310 may not be connected to the aerial vehicle 300 via a cable. When the seismic sensor is deployed, it may free fall to the ground, embed therein, and communicate acquired seismic data wirelessly to the aerial vehicle 300 via a transceiver 314.

Transceiver 314 may be configured to transmit and receive data at the aerial vehicle 300. Transceiver 314 may further be configured to enable the aerial vehicle 300 to operate in a mesh network, a hub and spoke network, and/or any other suitable communication protocol in order to transmit and receive data from other aerial vehicles and/or the controller device within the system environment.

The aerial vehicle 300 further includes a vehicle controller 316. Vehicle controller 316 is configured to control operations of the aerial vehicle 300 and to facilitate the functionality as discussed herein.

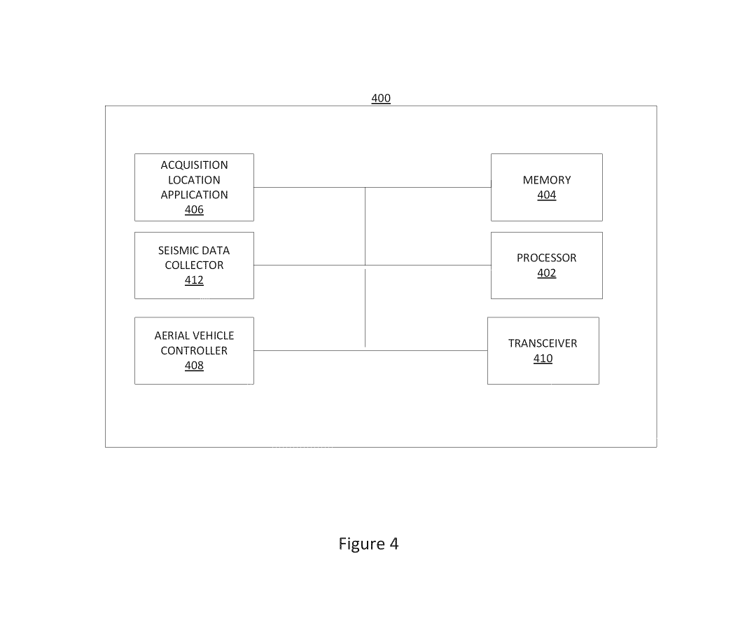

FIG. 4 illustrates additional components of a controller device 400 in accordance with some embodiments. As shown in FIG. 4, the controller device 400 may include a processor 402, and a memory 404, which may be implemented in a manner similar to the implementation of processors 202, memory devices 204, and storage devices 210 as discussed above with regard to FIG. 2. Controller device 400 may further include and/or be configured to execute software suitable to process data to facilitate the functionality as discussed herein Controller device 400 may further include an acquisition location application 406. The acquisition location application 406 may be implemented, for example, in software as a set of computer-readable instructions stored in memory and accessible by the processor 402. The acquisition location application 406 may be configured to receive information relating to and identifying an area in which seismic data is to be acquired. The application may determine one or more acquisition locations in which seismic sensors may be optimally positioned in order to acquire seismic data.

The controller device 400 may further include an aerial vehicle controller 408 to facilitate control of the aerial vehicles. The aerial vehicle controller 408 may provide acquisition location information representing the acquisition locations determined by the acquisition location application 406 to the aerial vehicles via a transceiver 410. The aerial vehicle controller 408 may further receive telemetric data from the aerial vehicles and process the telemetric data.

The transceiver 410 may be configured to transmit and receive data at the controller device 400. Transceiver 410 may further be configured to enable the controller device 400 to operate in a mesh network, a hub and spoke network, and/or any other suitable communication protocol in order to transmit and receive data from aerial vehicles within the system environment 100.

The controller device 400 may further include a seismic data collector 412. The seismic data collector 412 may be implemented in software, hardware or firmware to facilitate collection of seismic data that is acquired by the aerial vehicles and provided to the controller device 400. For example, the seismic data collector 412 may receive the data that is provided from aerial vehicles and store the acquired seismic data in the memory 404. According to some embodiments, the seismic data collector 412 may be located on a device that is separate from the collector device 400 and the seismic data that is acquired by the aerial vehicles may be stored and/or processed remotely from controller device 400. The controller device 400 may further include components, not shown, that facilitate processing of the seismic data.

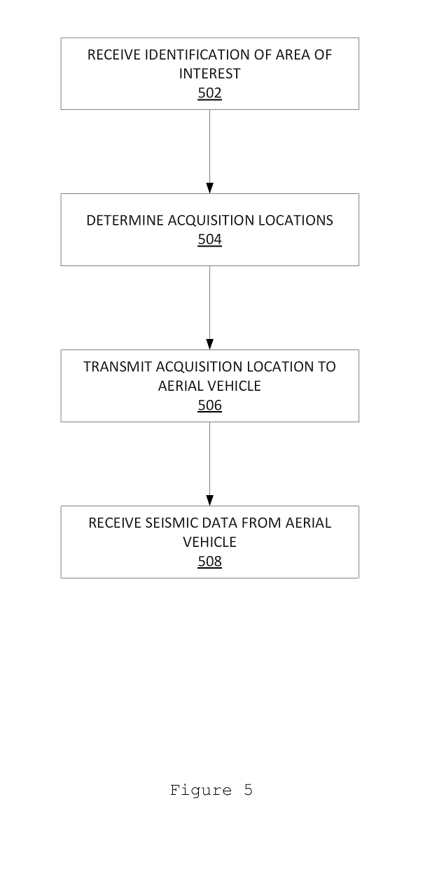

FIG. 5 illustrates an example flow diagram of a method for receiving seismic data from an aerial vehicle. The method depicted in FIG. 5 may be performed, for example, by controller device 106 depicted in FIG. 1, or controller device 400 depicted in FIG. 4. As shown in FIG. 5, information identifying an area of interest is received (502). The area of interest may represent boundary information identifying an area where seismic data is desired to be acquired. This may be identified via a user interface where coordinate data may be input at the controller device 106 or at a device remote to controller device 106 and transmitted to controller device 106. The user interface may be used to identify on a map displayed on a display device an area via a bounding box, a closed-curve shape, or via any other manner in which an area may be identified.

One or more acquisition locations within the identified area of interest may be determined (504). The one or more acquisition locations may be determined via algorithms that analyze the identified area of interest and determine optimal locations to position seismic sensors to acquire seismic data that may be analyzed in order to determine the structure of the earth.

The identification of the area of interest and the determination of the acquisition locations may be determined via acquisition location application 406 illustrated in FIG. 4.

Information identifying the determined acquisition location may be transmitted to an aerial vehicle (506). For example, the aerial vehicle controller 408 may determine how many locations were determined by the acquisition location application 406. The aerial vehicle controller 408 may assign and transmit each of the determined acquisition locations to a respective aerial vehicle. Where there are more acquisition locations than there are available aerial vehicles, one or more aerial vehicles may be assigned multiple acquisition locations. Aerial vehicles that are assigned multiple acquisition locations may perform a round trip for each of the acquisition locations to collect seismic data. Each of these trips may be controlled by the aerial vehicle controller 408.

Seismic data is received from the aerial vehicle (508). For example, the seismic data that is acquired by the aerial vehicle is received, via wired or wireless communication via transceiver 410 at the controller device 400.

In some embodiments, telemetric data may be received at the controller device 400 in order to facilitate control of the aerial vehicles and their acquisition of seismic data. For example, as noted above, each aerial vehicle is provided acquisition location information. This information may include an acceptable level of deviation from the location represented by the location information. Once the aerial vehicle reaches the location, the location information may identify an acceptable landing point within the deviation from the given location. If the aerial vehicle cannot identify an acceptable landing point, the aerial vehicle may report back to the controller device telemetric data indicating such and may request further instruction from the controller device. In response to the received telemetric data that the aerial vehicle could not find an acceptable landing point, the controller device may then communicate with the acquisition location application 406 in order to determine an updated acquisition location. Information identifying the updated acquisition location may be transmitted to the aerial vehicle as a change location instruction. The aerial vehicle may then navigate to the updated acquisition location. In some embodiments, the failure of one aerial vehicle to navigate to an acceptable landing point may result in updated acquisition locations of one or more other aerial vehicles. Thus, the controller device may transmit a change location instruction to the aerial vehicles that have updated acquisition locations.

For another example, when an aerial vehicle is in position on the ground at the location, or when the seismic sensor is properly deployed an in place, the aerial vehicle may report a “ready” signal to the controller device.

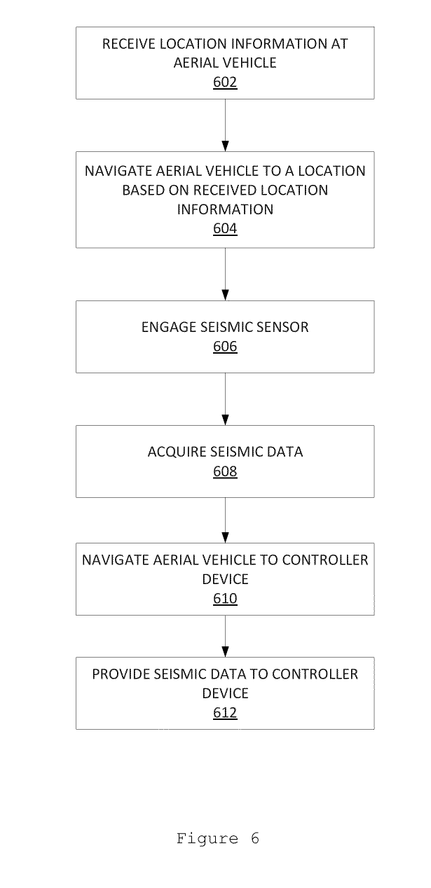

FIG. 6 illustrates an example flow diagram of a method for providing seismic data to a controller device. The method depicted in FIG. 6 may be performed, for example, by an aerial device 102 or 104 depicted in FIG. 1, or the aerial device 300 depicted in FIG. 3. As shown in FIG. 6, location information is received (602). The location information may be received via transceiver 314 as illustrated in FIG. 3. The aerial vehicle is navigated to a location based on the received location information (604). For example, the vehicle controller 316 uses the received information and GPS 306 to navigate the aerial vehicle to the acquisition location represented by the acquisition location information.

The seismic sensor is engaged (606). For example, when the aerial vehicle determines that it is positioned at the location represented by the location information, the seismic sensor is engaged. In some embodiments, the aerial vehicle drops the seismic from altitude such that the seismic sensor embeds itself at an acceptable depth in the ground. In some embodiments, the drop may occur from 10 meters or less. In certain embodiments, one or more aerial vehicles conduct test drops to determine an appropriate height from which to drop the seismic sensors in the particular terrain. In other embodiments, the aerial vehicles may reverse a thrust of one or more motors on the aerial vehicle in order to thrust the aerial vehicle towards the ground in order to embed the seismic sensors.

In some embodiments, where the seismic sensor is configured to be a integrated in the aerial vehicle, the aerial vehicle motor is turned off and the seismic sensor is set to acquire seismic data. In some embodiments, the seismic sensor is deployed via a seismic sensor deployment 312.

In some embodiments, testing may occur in order to determine if a seismic sensor of a first aerial vehicle is sufficiently embedded in the ground to properly receive seismic data based on deployment of a seismic sensor of a second aerial vehicle. For example, after the seismic sensor of the first aerial vehicle is deployed, the first aerial vehicle may transmit telemetric data to the controller device indicating that the seismic sensor was deployed. Subsequent to the transmission of the telemetric data indicating the seismic sensor of the first aerial vehicle was deployed, a second, or another, aerial vehicle may deploy its seismic sensor. If the seismic sensor of the first aerial vehicle detects, or acquires, the seismic data of the seismic sensor of the second aerial vehicle hitting the ground, this may indicate that the seismic sensor of the first aerial vehicle is properly embedded in the ground and ready to acquire seismic data. Telemetric data indicating the first aerial vehicle sensed the seismic sensor of the second aerial vehicle may be transmitted to the controller device. If the first aerial vehicle does not detect, or acquire seismic data of the seismic sensor of the second aerial vehicle hitting the ground, then telemetric data indicating detection of the seismic sensor of the second aerial vehicle may be sent to the controller device.

When the controller device receives telemetric data from the second aerial vehicle that the seismic sensor is deployed, the controller device may check to determine if telemetric data from the first aerial vehicle was received indicating that the first aerial vehicle detected, or acquired seismic data of the seismic sensor of the second aerial vehicle hitting the ground. If the telemetric data was not received, then the controller device may transmit an instruction to the first aerial vehicle to redeploy the seismic sensor of the first aerial vehicle. In some embodiments, where the seismic sensor is affixed to the first aerial vehicle, the first aerial vehicle may reposition itself at the same location in order to attempt to properly position the seismic sensor. In some embodiments where the seismic sensor is connected to the aerial vehicle via a cable, the first aerial vehicle may rise in altitude thereby dislodging the seismic sensor from the ground, and attempt to redeploy the seismic sensor, for example, by reeling in the cable an redeploying the seismic sensor, or rapidly reducing altitude in an attempt to properly embed the seismic sensor in the ground. Telemetric data regarding the redeployment of the seismic sensor may be transmitted to the controller device.

In some embodiments, the process described above may be repeated by the other aerial devices in order to determine whether the seismic sensors are properly embedded in the ground. The last aerial vehicle to deploy the seismic sensor may be verified via deployment of a source by the source device.

In some embodiments, once all aerial vehicles are in the assigned acquisition locations, a final test micro-seismic event may be generated to ensure that the aerial vehicles are in proper location and online. The aerial vehicles may communicate status information to each other, directly to the controller device, to a remote third party, or some combination thereof. In certain embodiments, a human may evaluate the results of the final test before authorizing the actual seismic event.

The source device may provide the seismic event in a variety of ways. The source device may comprise explosive materials for generating the seismic event. The source drone may drop a heavy object. A thumper device may traverse a path in the identified area of interest. Various approaches for generating a seismic event may be used in addition to the above.

Returning to FIG. 6, seismic data may be acquired (608). Once the seismic sensor is embedded in the ground, and a source is deployed, the seismic sensor may acquire seismic data and provide the acquired seismic data to the aerial vehicle, for example, wirelessly, via a cable, or directly. The acquired seismic data may be stored in the memory. In some examples, processing may be performed on the acquired data at the aerial vehicle.

The aerial vehicle is navigated to the controller device (610). Once the seismic data is acquired, the aerial vehicle is navigated to the controller device via the vehicle controller 316 and the GPS 306.

The acquired seismic data is provided to the controller device (612). In some embodiments, after the aerial vehicle arrives at the seismic acquisition control vehicle, the aerial vehicle may land at a docking station, an inductive charging landing plate that may include one or more magnets to facilitate positioning of the aerial vehicle on the inductive charging landing plate, or another suitable location to recharge and to provide the acquired seismic data. The acquired seismic data may be provided to the controller device or, in some embodiments, to another device, for storage and processing.

The foregoing description of the present disclosure, along with its associated embodiments and examples, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments.

Those skilled in the art will appreciate that the above-described componentry is merely one example of a hardware or software configuration, and that the processor system 200 may include any type of hardware components, including any necessary accompanying firmware or software, for performing the disclosed implementations. The processor system 200 may also be implemented in part or in whole by electronic circuit components or processors, such as application-specific integrated circuits (ASICs) or field-programmable gate arrays (FPGAs).

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents. Further, in the above description and in the below claims, unless specified otherwise, the term “execute” and its variants are to be interpreted as pertaining to any operation of program code or instructions on a device, whether compiled, interpreted, or run using other techniques.

The foregoing description of the present disclosure, along with its associated embodiments and examples, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments. For example, the same techniques described herein with reference to the processor system 100 may be used to execute programs according to instructions received from another program or from another processor system altogether. Similarly, commands may be received, executed, and their output returned entirely within the processing and/or memory of the processor system 100. Accordingly, neither a visual interface command terminal nor any terminal at all is strictly necessary for performing the described embodiments.

For example, the same techniques described herein with reference to the processor system 200 may be used to execute programs according to instructions received from another program or from another processor system altogether. Similarly, commands may be received, executed, and their output returned entirely within the processing and/or memory of the processor system 200. Accordingly, neither a visual interface command terminal nor any terminal at all is strictly necessary for performing the described embodiments.

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents. Further, in the above description and in the below claims, unless specified otherwise, the term “execute” and its variants are to be interpreted as pertaining to any operation of program code or instructions on a device, whether compiled, interpreted, or run using other techniques.

What is claimed is:

1. A method for acquiring seismic data, comprising:
receiving location information at an aerial vehicle including a seismic sensor;
navigating the aerial vehicle to a location based on the location information;
engaging the seismic sensor;
acquiring seismic data by the seismic sensor; and
transmitting the seismic data acquired at the seismic sensor to the controller device.

2. The method of claim 1, further comprising:
detecting engagement of a seismic sensor of another aerial vehicle via the seismic sensor of the aerial vehicle; and
transmitting an indication of the engagement of the seismic sensor of the another aerial vehicle.

3. The method of claim 1, wherein engaging the seismic sensor comprises:
releasing a holding mechanism holding the seismic sensor.

4. The method of claim 1, wherein engaging the seismic sensor comprises:
reversing a thrust of a motor of the aerial vehicle.

5. The method of claim 1, further comprising:
transmitting telemetric data to the controller device.

6. The method of claim 5, further comprising:
receiving a navigation instruction from the controller device based on the telemetric data transmitted to the controller device; and
navigating the aerial vehicle based on the navigation instruction received from the controller device.

7. The method of claim 1, wherein the aerial vehicle operates in a mesh network and communicates with one of a plurality of other aerial vehicles communicably linked by the mesh network.

8. The method of claim 1, wherein the aerial vehicle operates in a hub and spoke network, the hub and spoke network communicably linking the aerial vehicle, the controller device, and a plurality of other aerial vehicles.

9. The method of claim 1, further comprising:
performing, via a processor at the aerial device, signal processing on the seismic data that was acquired by the seismic sensor.

10. An apparatus, comprising:
a memory storing a set of instructions; and
a processor to execute the stored set of instructions to perform a method to:
receive an identification of an area of interest;
determine a plurality of acquisition locations within the received area of interest;
transmit one of the plurality of acquisition locations to an aerial vehicle; and
receive seismic data from an aerial vehicle.

11. The apparatus of claim 10, wherein the processor is to execute the stored set of instructions to perform the further method to:
receive telemetric data from the aerial vehicle.

12. The apparatus of claim 11, wherein the processor is to execute the stored set of instructions to perform the further method to:
transmit a change location instruction to the aerial vehicle in response to the telemetric data received from the aerial vehicle.

13. The apparatus of claim 10, wherein the apparatus is communicably linked to a docking station, wherein the seismic data that is received from the aerial vehicle is transmitted to the apparatus via the docking station.

14. The apparatus of claim 10, wherein the seismic data that is received from the aerial vehicle is transmitted wirelessly.

15. The apparatus of claim 10, wherein the apparatus further comprises a controller aerial vehicle.

16. The apparatus of claim 10, wherein the apparatus further comprises a land vehicle.

17. An apparatus, comprising:
an aerial vehicle, the aerial vehicle comprising:
a positioning system that determines location of the apparatus;
a seismic sensor that senses seismic data;
a memory that stores seismic data that is sensed by the seismic sensor; and
a transceiver that provides telemetric data and the seismic data to a controller device.

18. The apparatus of claim 17, wherein the aerial vehicle is a remotely controlled aerial vehicle.

19. The apparatus of claim 17, wherein the aerial vehicle is an autonomous aerial vehicle.

20. The apparatus of claim 19, further comprising:
a deployment mechanism which deploys the seismic sensor from the aerial vehicle for installation into a ground.
